(19) United States
(12) Patent Application Publication
(10) Pub. No.: US 2026/0039501 A1
(43) Pub. Date: Feb. 5, 2026

(54) CONTROL TERMINAL, COMMUNICATION DEVICE, COMMUNICATION SYSTEM, CONTROL METHOD, AND RECORDING MEDIUM

(71) Applicant: Panasonic Intellectual Property Management Co., Ltd., Osaka (JP)

(72) Inventors: Takuya HIRASAKI, Osaka (JP); Azusa NAGAHAMA, Osaka (JP)

(21) Appl. No.: 19/268,677

(22) Filed: Jul. 14, 2025

(30) Foreign Application Priority Data
Aug. 2, 2024 (JP) 2024-128132

(51) Int. Cl. H04L 12/28; H04W 12/69

(52) U.S. Cl. CPC H04L 12/2816; H04W 12/69; H04L 2012/2841

(57) ABSTRACT

A control terminal and the like are provided which can suppress an unintended behavior caused by two control signals. The control terminal belonging to a mesh network to which a plurality of communication devices belong includes a communicator. When the control terminal receives a predetermined operation for instructing the control terminal to perform control on the plurality of communication devices, the communicator transmits a first control signal to a communication device that is located within a wireless communication range of the control terminal and transmits a second control signal to the plurality of communication devices via the mesh network. First identification information included in the first control signal and second identification information included in the second control signal are in a predetermined correspondence.

### CROSS REFERENCE TO RELATED APPLICATION

This application claims the benefit of priority of Japanese Patent Application Number 2024-128132, filed on Aug. 2, 2024, the entire content of which is hereby incorporated by reference.

### TECHNICAL FIELD

The present disclosure relates to a control terminal, a communication device, a communication system, a control method, and a recording medium.

### BACKGROUND ART

A technique for controlling a communication device such as a lighting fixture using two types of control signals is proposed. Japanese Unexamined Patent Application Publication (Translation of PCT Application) No. 2022-538803 (Patent Literature (PTL) 1) discloses a lighting system (lighting control system) which controls a lighting fixture using one control signal (scene control command) and the other control signal (single control command).

### SUMMARY

Disadvantageously, when as in the technique disclosed in PTL 1, control signals are transmitted and received in two types of communication modes, a communication device which has received two control signals performs control twice, with the result that control different from that intended by a user is performed.

An object of the present disclosure is to provide a control terminal, a communication device, a communication system, a control method, and a recording medium which can suppress an unintended behavior caused by two control signals.

A control terminal according to an aspect of the present disclosure is a control terminal belonging to a mesh network to which a plurality of communication devices additionally belong, the control terminal includes: a communicator, when the control terminal receives a predetermined operation for instructing the control terminal to perform control on the plurality of communication devices, the communicator: transmits a first control signal to a communication device that is located within a wireless communication range of the control terminal; and transmits a second control signal to the plurality of communication devices via the mesh network, and first identification information included in the first control signal and second identification information included in the second control signal are in a predetermined correspondence.

A communication device according to an aspect of the present disclosure is a communication device that is one of a plurality of communication devices belonging to a mesh network, and the communication device includes: an acquirer that acquires: a first control signal that is directly transmitted into a wireless communication range of a control terminal; and a second control signal that is transmitted via the mesh network, the first control signal and the second control signal being control signals that are transmitted by the control terminal belonging to the mesh network to control at least a part of the plurality of communication devices; and a controller that: transmits the second control signal to the mesh network without performing control based on the second control signal when the first control signal and the second control signal are acquired by the acquirer; and performs the control based on the second control signal, and transmits the second control signal to the mesh network when the first control signal is not acquired by the acquirer and the second control signal is acquired by the acquirer.

A communication system according to an aspect of the present disclosure includes: a plurality of communication devices each being the communication device described above, the plurality of communication devices belonging to the mesh network; and one or a plurality of control terminals each being the control terminal described above, the one or the plurality of control terminals belonging to the mesh network.

A control method according to an aspect of the present disclosure is a control method that is performed by a control terminal to control a plurality of communication devices belonging to a mesh network, and the control method includes: receiving a predetermined operation; transmitting a first control signal for directly communicating with and controlling a communication device that is located within a wireless communication range of the control terminal; and transmitting a second control signal including second identification information that is in a predetermined correspondence with first identification information included in the first control signal, the second control signal being transmitted to control at least a part of the plurality of communication devices via the mesh network.

The present disclosure can be realized not only as the control method described above but also as a non-transitory computer-readable recording medium having stored therein a program for causing a computer to execute the control method.

The control terminal, the communication device, the communication system, the control method, and the recording medium according to the present disclosure can suppress an unintended behavior caused by two control signals.

### BRIEF DESCRIPTION OF THE DRAWINGS

The figures depict one or more implementations in accordance with the present teaching, by way of examples only, not by way of limitations. In the figures, like reference numerals refer to the same or similar elements.

FIG. 1 is a block diagram showing the functional configuration of a communication system according to an embodiment.

FIG. 2 is a diagram showing an example of the network configuration of a mesh network in the embodiment.

FIG. 3 is a flowchart illustrating the operation of a control terminal according to the embodiment.

FIG. 4 is a schematic view of the signal format of control signals in the embodiment.

FIG. 5 is a flowchart illustrating the operation of a communication device according to the embodiment.

### DETAILED DESCRIPTION

### Embodiment

A control terminal, a communication device, a communication system, a control method, and a recording medium according to an embodiment of the present disclosure will be described in detail below with reference to drawings. The embodiment described below indicates a specific example of the present disclosure. Numerical values, constituent elements, the arrangement and connection of the constituent elements, steps, the order of the steps, and the like shown in the following embodiment are examples, and are not intended to limit the present disclosure. Among the constituent elements in the following embodiment, constituent elements which are not recited in the independent claims are described as optional constituent elements in a form.

The drawings each are schematic diagrams, and are not exactly shown. In the drawings, substantially the same configurations are identified with the same reference signs, and repeated description may be omitted or simplified.

Unless otherwise specified, ordinal numerals such as “first” and “second” in the present disclosure do not mean the number or the order of constituent components or the like, but are used to avoid confusion and to distinguish between constituent components or the like of the same type.

### [Configuration]

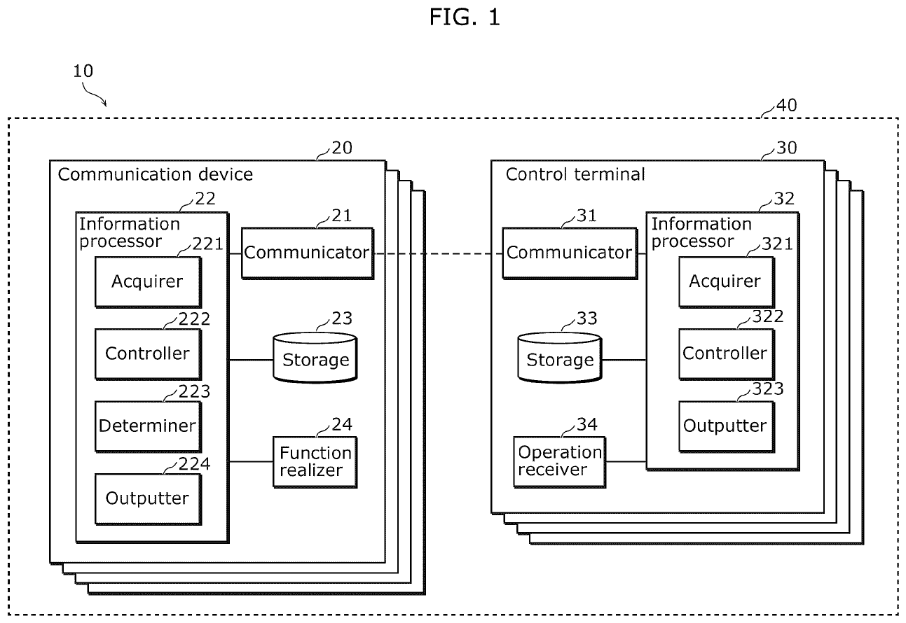

The configuration of a communication system according to the present embodiment will first be described. FIG. 1 is a block diagram showing the functional configuration of communication system 10 according to the embodiment. Communication system 10 includes a plurality of communication devices 20 and one or a plurality of control terminals 30.

In communication system 10, each of communication devices 20 and one or a plurality of control terminals 30 includes a wireless communication function, and communication devices 20 and one or a plurality of control terminals 30 form mesh network 40. Mesh network 40 is an example of a wireless network.

Mesh network 40 may include a device other than communication devices 20 and control terminals 30. For example, mesh network 40 may include a device such as an environmental sensor or a projector (not shown).

For example, when communication device 20 is a lighting device, information transmitted via mesh network 40 is control information for performing lighting control, extinction control, or dimming control on communication device 20. When communication device 20 serving as an environmental sensor belongs to mesh network 40, the measurement value (sensing information) of the environmental sensor is transmitted.

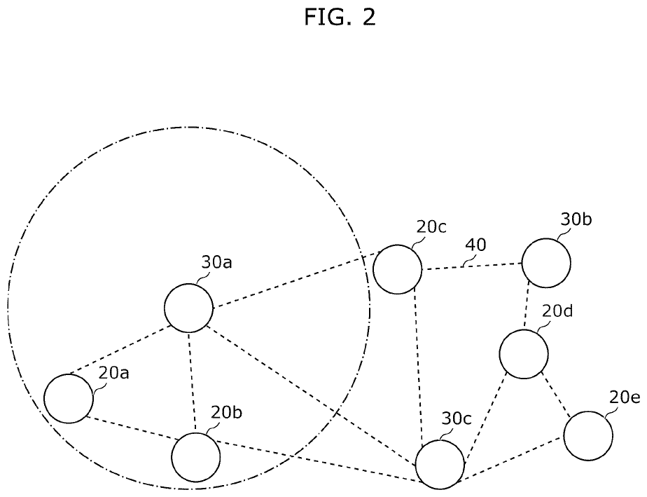

FIG. 2 is a diagram showing an example of the network configuration of mesh network 40 in the embodiment. Each circle in FIG. 2 corresponds to one communication device 20 or control terminal 30 (in other words, a communication node). In the example shown in FIG. 2, communication devices 20a to 20e serving as communication devices 20 and three control terminals 30a to 30c serving as control terminals 30 belong to mesh network 40. A circle indicated by alternate long and short dashed lines with control terminal 30a in the center indicates the wireless communication range of control terminal 30a, that is, indicates a range within which control signals transmitted by control terminal 30a reach. Communication devices 20a and 20b receive the control signals transmitted by control terminal 30a by direct wireless communication and communication via mesh network 40. Communication devices 20c to 20e and control terminals 30b and 30c receive the control signals transmitted by control terminal 30a by communication via mesh network 40.

Here, the transmission of information in communication via mesh network 40 will be described. In mesh network 40, when information is transmitted from a certain communication node (which is also referred to as a first communication node) to another communication node (which is also referred to as a second communication node), the information is transmitted in, for example, a routing mode, but may be transmitted in another mode such as a flooding mode.

In mesh network 40, a communication path is set which can distribute information to communication nodes belonging to mesh network 40 in advance. When the first communication node transmits, in a unicast mode, information including the address information (destination information) of the second communication node based on the set communication path, the other communication nodes that have received this information and belong to mesh network 40 identical to the first communication node further transmit the received information in the unicast mode based on the set communication path. In other words, the other communication nodes relay the information. The relay of the information as described above is repeated in identical mesh network 40, and thus the second communication node can receive the information transmitted by the first communication node.

Although in mesh network 40, the communication path is set which can distribute information to communication nodes belonging to mesh network 40 in advance, the communication path may be changed as necessary depending on the signal strength of the communication nodes.

The first communication node may broadcast the information including the address information (destination information) of the second communication node, and each of the other communication nodes that have received this information and belong to mesh network 40 identical to the first communication node may relay the received information and further broadcast the received information. The relay of the information as described above is repeated in identical mesh network 40, and thus the information transmitted by the first communication node is distributed to all the communication nodes belonging to mesh network 40 identical to the first communication node. Hence, the second communication node can receive the information transmitted by the first communication node.

With reference back to FIG. 1, communication device 20 will be described. Communication device 20 includes a wireless communication function, and communication devices 20 form mesh network 40 together with one or a plurality of control terminals 30. Communication device 20 has the function of relaying the acquired control signal via mesh network 40 to other communication device 20.

Communication device 20 is, for example, a device related to lighting. When communication device 20 is a lighting device, communication device 20 is, for example, a base light which is installed on the ceiling of an indoor space and illuminates the indoor space. Communication device 20 has the function of applying light to the indoor room based on the control signal acquired via mesh network 40. The form of communication device 20 is not particularly limited, and may be a celling light, a down light, a spot light, or the like. When communication device 20 is a scheduler, communication device 20 controls other communication devices 20 serving as lighting devices to a predetermined dimming state at a predetermined time based on a predetermined schedule. For example, communication device 20 may be another device related to lighting such as an environmental sensor or a camera.

Specifically, communication device 20 includes communicator 21, information processor 22, storage 23, and function realizer 24.

Communicator 21 is a wireless communication circuit for wireless communication (more specifically, radio communication) with control terminal 30 and other communication devices 20 performed by communication device 20. Communicator 21 performs communication via mesh network 40 formed by communication devices 20 and one or a plurality of control terminals 30. Specifically, communicator 21 performs wireless communication according to a communication standard such as Bluetooth (registered trademark) Low Energy (BLE) or Bluetooth (registered trademark) mesh.

Information processor 22 executes information processing and the like for operating communication device 20. For example, information processor 22 controls function realizer 24 to operate communication device 20. Information processor 22 is realized, for example, by a microcomputer, but may be realized by a processor or a dedicated circuit. The hardware, such as a microcomputer or a processor, of information processor 22 executes a computer program (software) stored in storage 23, and thus the function of information processor 22 is realized. Specifically, information processor 22 includes acquirer 221, controller 222, determiner 223, and outputter 224.

Acquirer 221 acquires the control signal.

Controller 222 performs control based on the acquired control signal.

Determiner 223 determines whether the acquired control signal satisfies a predetermined condition.

Outputter 224 transmits the acquired control signal to other communication devices 20.

Storage 23 is a storage device in which various types of information necessary for the operation of communication device 20 are stored. Storage 23 is realized, for example, by a semiconductor memory. The computer program stored in storage 23 includes a dedicated application program for operating communication device 20.

Function realizer 24 is a device for realizing the function of communication device 20 in the operation of communication device 20. Function realizer 24 is controlled by information processor 22. When communication device 20 is a lighting device, function realizer 24 is, for example, a light source which emits white light into an indoor space to illuminate the indoor space. Function realizer 24 is realized, for example, by an LED element, but may be realized by another light emitting element such as a semiconductor laser, an organic EL, or an inorganic EL.

Control terminal 30 will then be described. Control terminal 30 includes a wireless communication function, and forms mesh network 40 together with communication devices 20 and other control terminals 30. Control terminal 30 is, for example, a remote controller for controlling communication device 20. Control terminal 30 may be portable. Specifically, control terminal 30 includes communicator 31, information processor 32, storage 33, and operation receiver 34.

Communicator 31 is a wireless communication circuit for wireless communication (more specifically, radio communication) with communication device 20 and other control terminals 30 performed by control terminal 30. Communicator 31 directly communicates with one or a plurality of communication devices 20 installed within the wireless communication range. Communicator 31 performs communication via mesh network 40 formed by communication devices 20 and one or a plurality of control terminals 30. Specifically, communicator 31 performs wireless communication according to a communication standard such as BLE or Bluetooth (registered trademark) mesh.

Information processor 32 executes information processing and the like for transmission of the control signal controlling communication device 20 performed by control terminal 30. Information processor 32 is realized, for example, by a microcomputer, but may be realized by a processor or a dedicated circuit. The hardware, such as a microcomputer or a processor, of information processor 32 executes a computer program (software) stored in storage 33, and thus the function of information processor 32 is realized. Specifically, information processor 32 includes acquirer 321, controller 322, and outputter 323.

Acquirer 321 acquires an operation received by operation receiver 34.

Controller 322 generates the control signal to be transmitted and the like based on information acquired by acquirer 321.

Outputter 323 outputs the control signal for controlling communication device 20 and the like.

Storage 33 is a storage device in which information necessary for information processing on a computer program and the like executed by information processor 32 is stored. Storage 33 is realized, for example, by a semiconductor memory or the like. The computer program stored in storage 33 includes a dedicated application program for causing control terminal 30 to operate as a control terminal of communication device 20.

Operation receiver 34 receives an operation performed by a user. Operation receiver 34 is realized, for example, by a press button or the like.

Here, a case where the user performs settings for control terminal 30 will be described. The user uses a setting terminal (not shown) to set, for example, a control target and details of control for the control signal which is transmitted when operation receiver 34 of each of control terminals 30 is operated.

The setting terminal is, for example, a portable terminal such as a smartphone, a tablet terminal, or a personal digital assistant (PDA). The setting terminal may be a dedicated remote controller which is used in communication system 10.

For example, the setting terminal uses a communication protocol different from that for mesh network 40 to communicate with one of devices which form mesh network 40. The communication described above is transmitted via mesh network 40, and thus settings for arbitrary control terminal 30 can be performed.

The user uses the setting terminal to be able to set the configuration of mesh network 40. In other words, the user uses the setting terminal to be able to cause communication device 20 or control terminal 30 to join mesh network 40 and to cause communication device 20 or control terminal 30 belonging to mesh network 40 to withdraw from mesh network 40.

### [Operation]

Regarding information exchanged in mesh network 40, a communication device which receives information further transmits the received information to another communication device, this operation is repeated, and thus the information is distributed to entire mesh network 40. In other words, the information exchanged in mesh network 40 is relayed by communication devices, and is transmitted in a relay manner.

Hence, for example, when the user operates a control terminal belonging to mesh network 40 to control a communication device to a desired state, a time for transmitting the information in the relay manner is needed so that the communication device is caused to reach the desired state. In a state where it is possible to control a plurality of communication devices which belong to mesh network 40 and are installed in a wide range, it is required to reduce a time necessary for performing the control.

Hence, a control terminal is proposed which transmits control signals in two communication modes. The control terminal as described above transmits the control signals in the two communication modes using a control signal which is directly transmitted to a communication device within the wireless communication range of the control terminal and using a control signal which is transmitted via mesh network 40. Advantageously, the control terminal as described above can quickly control a communication device which is within the wireless communication range of the control terminal, that is, which is installed near the user who operates the control terminal. Disadvantageously, however, since the control terminal transmits the two control signals, the communication device installed within the wireless communication range of the control terminal receives the two control signals having the same details of control to perform the same details of control twice.

Communication system 10 according to the embodiment causes a first control signal directly transmitted to communication device 20 within the wireless communication range of control terminal 30 and a second control signal transmitted via mesh network 40 to have a predetermined correspondence, and thereby can suppress an unintended behavior which is performed by communication device 20 acquiring the two control signals and is caused by the two control signals.

The user can use the first control signal to bring communication device 20 within the wireless communication range of control terminal 30, that is, around the user into a desired controlled state in a relatively short time, and can use the second control signal to bring all communication devices 20 belonging to mesh network 40 into a desired controlled state.

The operation of each of control terminal 30 and communication device 20 according to the embodiment will be described below.

### [Operation of Control Terminal]

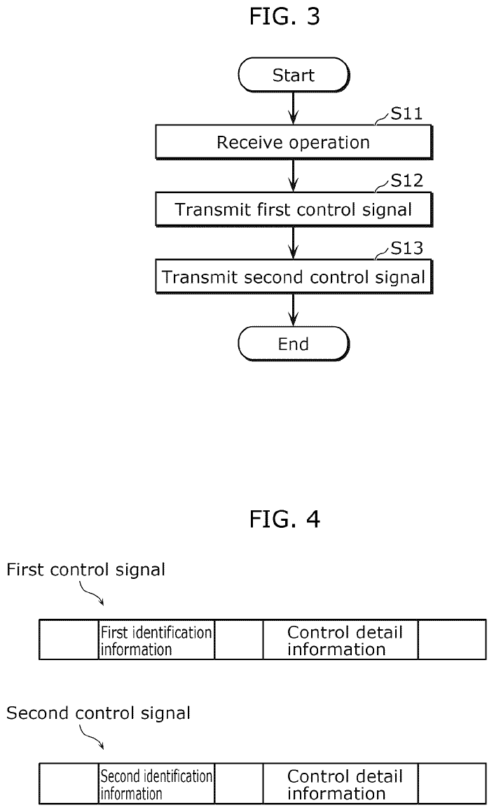

The operation of control terminal 30 will first be described. FIG. 3 is a flowchart illustrating the operation of control terminal 30 according to the embodiment. FIG. 4 is a schematic view of the signal format of the control signals in the embodiment.

Control terminal 30 first receives an operation performed by the user (S11). For example, the user presses down the press button which is operation receiver 34. The pressing down of the button is an example of a predetermined operation.

Then, control terminal 30 transmits the first control signal (S12). Specifically, outputter 323 uses communicator 31 to transmit the first control signal. The first control signal is a control signal for controlling communication device 20 located within the wireless communication range of control terminal 30. The first control signal is transmitted, for example, in a direct broadcasting mode.

As shown in FIG. 4, the first control signal includes first identification information and control detail information. The first identification information is, for example, a first number. The first number can be an arbitrary number in a predetermined range. The control detail information is information which indicates the details of control performed by communication device 20 receiving the control signal. The control detail information is caused to correspond to the predetermined operation which is set by the user using the setting terminal in advance.

Control terminal 30 finally transmits the second control signal (S13). Controller 322 generates the second control signal, and outputter 323 uses communicator 31 to transmit the second control signal generated by controller 322. The second control signal is a control signal for controlling communication devices 20 via mesh network 40. Here, controller 322 transmits the first control signal, and then transmits the second control signal, for example, after a relatively short period of 1 second or the like. The second control signal is transmitted, for example, in a direct unicast mode.

As shown in FIG. 4, the second control signal includes second identification information and control detail information. The second identification information is, for example, a second number. The first identification information and the second identification information are in a predetermined correspondence. For example, a difference between the first number and the second number is a predetermined constant. For example, when the predetermined constant is “1000”, and the first number is “0001”, the second number is “1001”.

As long as the first identification information and the second identification information are in the predetermined correspondence, the correspondence is not particularly limited. The correspondence may be, for example, that the sum of the first number and the second number is constant, or that the second number is a predetermined constant multiple of the first number. However, the first identification information and the second identification information are different from each other. For example, the first number and the second number are not the same number but different numbers.

The control detail information included in the first control signal and the control detail information included in the second control signal are the same. In other words, the details of control which the first control signal instructs communication device 20 to perform and the details of control which the second control signal instructs communication device 20 to perform are the same.

As shown in FIG. 4, controller 322 generates the second control signal by overwriting the first identification information with the second identification information in the region of the first control signal where the first identification information is written in the predetermined signal format.

Controller 322 may generate the first control signal and the second control signal separately. For example, the first identification information and the second identification information are generated based on processing including a predetermined pattern such as an increment or a decrement. Controller 322 performs the processing including the predetermined pattern on identification information included in a control signal generated in the past to be able to generate the first identification information and the second identification information separately.

In the operation as described above, when control terminal 30 receives the predetermined operation, control terminal 30 transmits the first control signal and the second control signal in which the first identification information included in the first control signal and the second identification information included in the second control signal are in the predetermined correspondence, and thereby can suppress an unintended behavior performed by communication device 20 acquiring the two control signals.

Here, each time communicator 31 receives the predetermined operation, communicator 31 transmits the first control signal in which the first identification information has been changed and the second control signal in which the second identification information has been changed. In other words, control terminal 30 transmits the control signal which includes the first identification information or the second identification information different from the first identification information or the second identification information included in the control signal transmitted last. Control terminal 30 may transmit the control signal which includes the first identification information or the second identification information different from the first identification information or the second identification information included in the control signal transmitted in the past.

### [Operation of Communication Device]

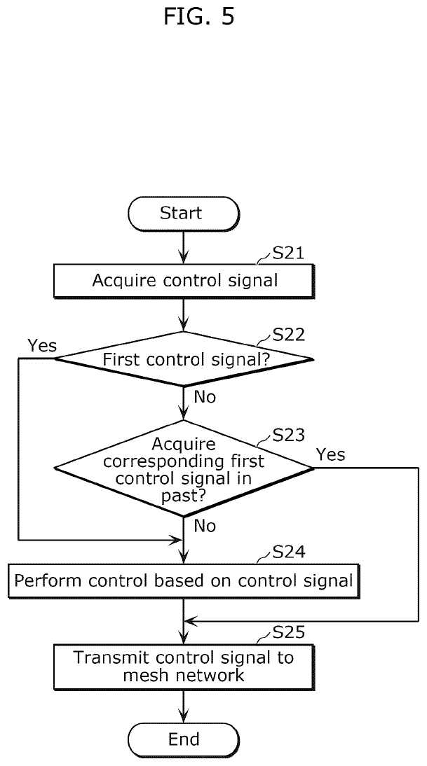

The operation of communication device 20 will then be described. FIG. 5 is a flowchart illustrating the operation of communication device 20 according to the embodiment.

Acquirer 221 first acquires the control signal (S21). Specifically, acquirer 221 of communication device 20 acquires the control signal received by communicator 21.

When acquirer 221 acquires the control signal, determiner 223 determines whether the acquired control signal is the first control signal (S22). For example, when identification information included in the acquired control signal is within the range of values which the first identification information can take, determiner 223 determines that the acquired control signal is the first control signal. For example, when the acquired control signal does not include information for instructing communication device 20 to transmit the control signal via mesh network 40, determiner 223 may determine that the acquired control signal is the first control signal.

When determiner 223 determines that the acquired control signal is not the first control signal (no in S22), that is, when determiner 223 determines that the acquired control signal is the second control signal, determiner 223 determines whether the corresponding first control signal has been acquired in the past (S23). For example, determiner 223 determines whether a control signal which matches a part other than the region including the identification information in the signal format of the acquired control signal has been acquired in the past.

When determiner 223 determines that the acquired control signal is the first control signal (yes in S22), or when determiner 223 determines that the corresponding first control signal has not been acquired in the past (no in S23), controller 222 performs control based on the control signal (S24). Specifically, when destination information included in the control signal includes communication device 20, controller 222 performs control based on the control signal. The control based on the control signal is, for example, control for adjusting the dimming state of a light source when communication device 20 is a lighting device.

When determiner 223 determines that the corresponding first control signal has been acquired in the past (yes in S23), or after the control based on the control signal is performed, outputter 224 uses communicator 21 to transmit the control signal to mesh network 40 (S25). When the destination information included in the control signal includes other communication device 20, outputter 224 uses communicator 21 to transmit the control signal to other communication device 20.

In the operation as described above, when communication device 20 receives two control signals having the same details of control, communication device 20 does not perform the same control, and thereby can suppress an unintended behavior performed by communication device 20.

### [Effects and Like]

Examples of techniques derived from the disclosure of the present specification include the following techniques. The techniques derived from the disclosure of the present specification will be described below together with effects and the like obtained by the techniques.

Technique 1 is control terminal 30 belonging to mesh network 40 to which a plurality of communication devices 20 additionally belong, control terminal 30 includes: communicator 31, when control terminal 30 receives a predetermined operation for instructing control terminal 30 to perform control on the plurality of communication devices 20, communicator 31: transmits a first control signal to communication device 20 that is located within a wireless communication range of control terminal 30; and transmits a second control signal to the plurality of communication devices 20 via mesh network 40, and first identification information included in the first control signal and second identification information included in the second control signal are in a predetermined correspondence.

Control terminal 30 as described above transmits the first control signal and the second control signal in which the first identification information included in the first control signal and the second identification information included in the second control signal are in the predetermined correspondence, and thereby can suppress an unintended behavior performed by communication device 20 acquiring the two control signals.

In technique 2 which is control terminal 30 of technique 1, the first identification information is a first number, the second identification information is a second number, and a difference between the first number and the second number is a predetermined constant.

Control terminal 30 as described above can transmit the pair of control signals which are caused to correspond to each other using the first number and the second number in the predetermined correspondence.

In technique 3 which is control terminal 30 of technique 1 or 2, the first control signal includes a predetermined signal format, and the second control signal is generated by overwriting the first identification information with the second identification information in a region of the first control signal where the first identification information is written in the predetermined signal format.

Control terminal 30 as described above can transmit the first control signal and the second control signal sharing the predetermined signal format, and easily generate the second control signal based on the first control signal.

In technique 4 which is control terminal 30 of technique 1 or 2, the first control signal and the second control signal are generated separately.

Since control terminal 30 as described above can generate the first control signal and the second control signal separately, processing for generating the control signals is simplified.

In technique 5 which is control terminal 30 of any one of techniques 1 to 4, each time control terminal 30 receives the predetermined operation, communicator 31 transmits: the first control signal in which the first identification information has been changed; and the second control signal in which the second identification information has been changed.

Each time control terminal 30 as described above receives the operation, the identification information included in the first control signal and the identification information included in the second control signal are changed, and thus it is possible to distinguish between the past control signal and the current control signal. For example, control terminal 30 as described above can contribute to measures against a replay attack. The replay attack is one of the means of an unauthorized access to mesh network 40 in which an unauthorized third party eavesdrops on an authorized control signal transmitted and received in mesh network 40, and retransmits the eavesdropped control signal to control communication devices 20 belonging to mesh network 40.

In technique 6 which is control terminal 30 of any one of techniques 1 to 5, each of the plurality of communication devices 20 is a device related to lighting.

Control terminal 30 as described above can suppress an unintended behavior performed by the device related to lighting acquiring the two control signals.

Technique 7 is a communication device that is one of a plurality of communication devices 20 belonging to mesh network 40, and communication device 20 includes: acquirer 221 that acquires: a first control signal that is directly transmitted into a wireless communication range of control terminal 30; and a second control signal that is transmitted via mesh network 40, the first control signal and the second control signal being control signals that are transmitted by control terminal 30 belonging to mesh network 40 to control at least a part of the plurality of communication devices 20; and controller 222 that: transmits the second control signal to mesh network 40 without performing control based on the second control signal when the first control signal and the second control signal are acquired by acquirer 221; and performs the control based on the second control signal, and transmits the second control signal to mesh network 40 when the first control signal is not acquired by acquirer 221 and the second control signal is acquired by acquirer 221.

When communication device 20 as described above receives two control signals having the same details of control, communication device 20 does not perform the same control, and thereby can suppress an unintended behavior performed by communication device 20.

Technique 8 is communication system 10 including: a plurality of communication devices 20 each being communication device 20 of technique 7, the plurality of communication devices 20 belonging to mesh network 40; and one or a plurality of control terminals 30 each being control terminal 30 of any one of techniques 1 to 6, the one or the plurality of control terminals 30 belonging to mesh network 40.

Even when the first control signal which can bring communication device 20 into a desired controlled state in a relatively short time and the second control signal which can bring all communication devices 20 belonging to mesh network 40 into a desired controlled state are used simultaneously, it is possible to suppress an unintended behavior performed by communication device 20 and caused by the two control signals.

Technique 9 is a control method that is performed by control terminal 30 to control a plurality of communication devices 20 belonging to mesh network 40, and the control method includes: receiving a predetermined operation; transmitting a first control signal for directly communicating with and controlling communication device 20 that is located within a wireless communication range of control terminal 30; and transmitting a second control signal including second identification information that is in a predetermined correspondence with first identification information included in the first control signal, the second control signal being transmitted to control at least a part of the plurality of communication devices 20 via mesh network 40.

In the control method as described above, the first control signal and the second control signal in which the first identification information included in the first control signal and the second identification information included in the second control signal are in the predetermined correspondence are transmitted, and thus it is possible to suppress an unintended behavior performed by communication device 20 receiving the two control signals.

Technique 10 is a non-transitory computer-readable recording medium having stored therein a program for causing control terminal 30 to perform the control method of technique 9.

The recording medium as described above can assist in suppressing an unintended behavior performed by communication device 20 receiving the two control signals.

### Other Embodiments

Although the embodiment has been described above, the present disclosure is not limited to the embodiment described above.

For example, the first control signal and the second control signal in the embodiment may be repeatedly transmitted a plurality of times. For example, when the predetermined operation performed by the user is received, outputter 323 of control terminal 30 may successively transmit the same first control signal 20 times at intervals of several milliseconds, and then successively transmit the same second control signal 20 times at intervals of several milliseconds. Control terminal 30 as described above repeatedly transmit the same control signal a plurality of times to be able to cause communication device 20 to receive the control signals more reliably.

For example, in the embodiment described above, the communication system is realized by a plurality of devices. When the communication system is realized by a plurality of devices as described above, how constituent elements (in particular, functional constituent elements) included in the communication system are assigned to a plurality of devices is not limited.

A communication method between devices in the embodiment described above is not particularly limited. In communication between devices, an unillustrated relay device (such as a gateway device) may be interposed.

In the embodiment described above, processing which is executed by a specific processor may be executed by another processor. The order of a plurality of processing steps may be changed, or a plurality of processing steps may be executed in parallel.

In the embodiment described above, constituent elements may be realized by executing a software program suitable for each of the constituent elements. A program executer such as a CPU or a processor may read and execute a software program recorded in a recording medium such as a hard disk or a semiconductor memory to realize each of the constituent elements.

The constituent elements may be realized by hardware. For example, the constituent elements may be circuits (or integrated circuits). These circuits may form one circuit as a whole, or may be separate circuits. Each of these circuits may be a general-purpose circuit or a dedicated circuit.

A general or specific form of the present disclosure may be realized by a system, a device, a method, an integrated circuit, a computer program, or a computer-readable recording medium such as a CD-ROM. The general or specific form may be realized by any combination of a system, a device, a method, an integrated circuit, a computer program, and a recording medium.

For example, the present disclosure may be realized as a control method executed by a computer such as the communication system according to the embodiment described above, or may be realized as a program (that is, a computer program product) for causing a computer to execute a control method. The present disclosure may be realized as a non-transitory computer-readable recording medium in which the program as described above is recorded.

Embodiments obtained by performing various types of variations conceivable by those skilled in the art on the embodiment and embodiments realized by arbitrarily combining constituent elements and functions in the embodiment without departing from the spirit of the present disclosure are also included in the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A control terminal belonging to a mesh network to which a plurality of communication devices additionally belong, the control terminal comprising:
a communicator,
wherein when the control terminal receives a predetermined operation for instructing the control terminal to perform control on the plurality of communication devices, the communicator:
transmits a first control signal to a communication device that is located within a wireless communication range of the control terminal; and
transmits a second control signal to the plurality of communication devices via the mesh network, and
first identification information included in the first control signal and second identification information included in the second control signal are in a predetermined correspondence.

2. The control terminal according to claim 1,
wherein the first identification information is a first number,
the second identification information is a second number, and
a difference between the first number and the second number is a predetermined constant.

3. The control terminal according to claim 1,
wherein the first control signal includes a predetermined signal format, and
the second control signal is generated by overwriting the first identification information with the second identification information in a region of the first control signal where the first identification information is written in the predetermined signal format.

4. The control terminal according to claim 1,
wherein the first control signal and the second control signal are generated separately.

5. The control terminal according to claim 1,
wherein each time the control terminal receives the predetermined operation, the communicator transmits: the first control signal in which the first identification information has been changed; and the second control signal in which the second identification information has been changed.

6. The control terminal according to claim 1,
wherein each of the plurality of communication devices is a device related to lighting.

7. A communication device that is one of a plurality of communication devices belonging to a mesh network, the communication device comprising:
an acquirer that acquires:
a first control signal that is directly transmitted into a wireless communication range of a control terminal; and
a second control signal that is transmitted via the mesh network, the first control signal and the second control signal being control signals that are transmitted by the control terminal belonging to the mesh network to control at least a part of the plurality of communication devices; and
a controller that:
transmits the second control signal to the mesh network without performing control based on the second control signal when the first control signal and the second control signal are acquired by the acquirer; and
performs the control based on the second control signal, and transmits the second control signal to the mesh network when the first control signal is not acquired by the acquirer and the second control signal is acquired by the acquirer.

8. A communication system comprising:
a plurality of communication devices each being the communication device according to claim 7, the plurality of communication devices belonging to the mesh network; and
one or a plurality of control terminals, the one or the plurality of control terminals belonging to the mesh network,
each of the one or plurality of control terminals comprising:
a communicator,
wherein when the control terminal receives a predetermined operation for instructing the control terminal to perform control on the plurality of communication devices, the communicator:
transmits a first control signal to a communication device that is located within a wireless communication range of the control terminal; and
transmits a second control signal to the plurality of communication devices via the mesh network, and
first identification information included in the first control signal and second identification information included in the second control signal are in a predetermined correspondence.

9. A control method that is performed by a control terminal to control a plurality of communication devices belonging to a mesh network, the control method comprising:
receiving a predetermined operation;
transmitting a first control signal for directly communicating with and controlling a communication device that is located within a wireless communication range of the control terminal; and
transmitting a second control signal including second identification information that is in a predetermined correspondence with first identification information included in the first control signal, the second control signal being transmitted to control at least a part of the plurality of communication devices via the mesh network.

10. A non-transitory computer-readable recording medium having stored therein a program for causing the control terminal to perform the control method according to claim 9.
